(19) United States
(12) Patent Application Publication
(10) Pub. No.: US 2009/0031430 A1
(43) Pub. Date: Jan. 29, 2009

(54) SOFTWARE ACTIVATION CONTROL METHOD

(76) Inventors: Scott MacDonald Ward, Aerdenhout (NL); Teunis Tel, Groningen (NL)

Correspondence Address: PAUL, HASTINGS, JANOFSKY & WALKER LLP, 875 15th Street, NW, Washington, DC, 20005, US

(21) Appl. No.: 11/913,834

(22) PCT Filed: May 13, 2005
(86) PCT No.: PCT/NL05/00370

§ 371 Date: May 8, 2008

(30) Foreign Application Priority Data
May 10, 2005 (NL) PCT/NL2005/000354

(51) Int. Cl. G06F 21/22

(52) U.S. Cl. 726/30

(57) ABSTRACT

A software application installation method installs a software application on a device such that the installed application can only be activated on said device. Thereto, an authorization application is installed as well on the device. During installation, the authorization application generates a software release code that is stored in a first and a second memory location, of which at least one is a memory location not accessible to a user. When the software application is later activated on the device, the authorization application compares the software release codes stored in said two memory locations. The application is only started if the software release codes correspond. Further, an authorization verification method is disclosed. A second party may verify the legitimacy of the installed application by storing device specific identification data and application specific installation data when a first connection is established and later comparing said data if a second or further connection is established.

The present invention relates to a method for protecting a software application against unauthorized use, to a method for controlling activation of a software application and to a method for verifying authorized use of a software application.

Digital data including software applications may easily be copied and distributed without consent of the proprietor of the data. To prevent such illegal copying and distribution of data and software applications, numerous copy protection methods have been proposed and introduced in the past years. However, these copy protection methods are generally compromised and the data or the software may still be copied and distributed, e.g. via the Internet. For example, serial numbers to be entered by users after installation of a software application may be retrieved on the Internet.

In WO 2004 111752 it is proposed to control activation (use) of digital data instead of controlling copying and distribution of the data. An authorization application is installed on a first device to control the use of the digital data. The authorization application is installed via a network, e.g. the Internet, through which a connection is made to a second device of another party. To control authorized use of the digital data, an authorization code is to be incorporated in the digital data before providing the digital data to the first device. The authorization code is verified by the authorization application before use of the digital data.

It is an object of the present invention to provide a method for controlling authorized use of digital data, in particular a software application that does not require a connection, such as a network connection, to a device of any other party.

To reach the above object, the present invention provides an installation method for installing a software application on a device, the method comprising:
providing first authorization data together with software application installation data;
providing a data carrier carrying second authorization data, at least part of said second authorization data being coupled to the specific data carrier on which said second authorization data are stored;
generating a software release code using at least the first authorization data and the second authorization data;
storing at least one of data for regenerating the software release code and the software release code in a secure first memory location such that said data are not accessible to a user of said device;
storing a copy of the software release code in a second memory location of said device.

In a further aspect, the present invention provides a method for controlling activation of a software application installed according to the above installation method, the method comprising:
retrieving the software release code from the first secure memory location;
retrieving a copy of the software release code from the second memory location;
comparing the copy of the software release code and the software release code;
activating the software application, if the software release code and the copy of the software release code correspond to each other.

In an aspect of the invention, retrieving the software release code from the first secure memory location may comprise retrieving data for regenerating the software release code; and regenerating the software release code.

The installation method according to the present invention generates a unique software release code and stores a copy of this software release code in the second memory location. Said copy may or may not be accessible to the user. The data needed for generating the software release code is stored in a secure memory location such that the data are not accessible to a user of the device on which the software application is installed. When activating the software again, the device may regenerate the software release code and compare it with the stored copy of the software release code. If the stored copy of the software release code and the regenerated software release code correspond to each other, the software application is activated.

The first authorization data provided together with the software application installation data comprise data for ensuring that second authorization data from the data carrier are required for installation. For example, the first authorization data may comprise an authorization application for performing the software activation control method or may be an application dedicated for installation. In an embodiment, the first authorization data may comprise a decryption application and/or decryption key, or a part thereof, for decrypting the second authorization data.

During installation or when activating the software application for the first time the second authorization data including the part identifying the data carrier or coupling such data to the data carrier is requested by the device.

The data carrier may be any kind of carrier, but a part of the second authorization data is preferably not accessible to a user of the software application. For example, in an embodiment, the data carrier is a code or marker printed on paper, e.g. a sticker. The code or marker may be retrievable only using dedicated equipment available to e.g. a device manufacturer. In such an embodiment, the device manufacturer retrieves the code or marker and provides it in the secure memory location for generation or regeneration of the software release code later.

In an embodiment, the data carrier is an electronic data carrier, i.e. a data carrier only readable using electronic means, for example a magnetic disk, an optical disk, a magneto-optical disk, an external memory extension or the like. The data carrier is provided with a serial number or the like, which number identifies the electronic data carrier. To prevent that any similar electronic data carrier may be used during installation, the electronic data carrier may carry encrypted data needed during installation of the software application. During installation, the encrypted data may be decrypted using the identification data of the electronic data carrier and possibly other data. Thus, the encrypted data may only de decrypted if they are stored on the original electronic data carrier and not if they are copied onto another carrier. Thus, in this embodiment, the identification data and the encrypted data together form the second authorization data. It is noted that the identification data are an example of data coupled to the data carrier. Data is considered to be coupled to the data carrier, if the data cannot be copied to another data carrier without disabling an installation of a software application, a re-install of the software application after a corruption and/or an activation of a software application in accordance with the present invention using said other data carrier.

In an embodiment encrypted data may be deleted from the data carrier during or after installation of the software application, thereby rendering another installation using the same data carrier impossible. In a further embodiment, the encrypted data on the data carrier may be altered during or after installation. Then, when an attempt is made to perform a second installation using the same data carrier, the installation may fail, since the encrypted data are not correct. However, the altered encrypted data may also indicate that the data may be used to re-install the original (authentic) software on a specific device on which the software application has been installed previously using the same data carrier. Thus, e.g. when the installed software application is corrupted, the application may be re-installed on the same device again. For example, the altered encrypted data on the data carrier may comprise the software release code.

In an embodiment the encrypted data on the data carrier may indicate a number of installations that may be performed using that data carrier, thus providing one data carrier for e.g. five installations. Alternatively, the data carrier may contain a number of second authorization data files. Such a data carrier is particularly suitable for companies maintaining a number of devices each running an authentic and licensed software application. After an installation, the encrypted data on the data carrier are altered to reflect that an installation is performed. Of course this data should be properly protected against illegal alterations, for example using a suitable encryption.

The software release code may be generated using any kind of data, but at least using the first authorization data and the second authorization data. Thus, the generated software release code may be made unique. The software release code may be generated further using a specific number or characteristic of the device on which the software application is installed, e.g. a BIOS serial number, a device serial number, a memory size, or the like, coupling the software release code to the device. Further, the software release code may be generated using a personal identification code, a code biometrically coupled to a user (e.g. an image of a finger print), or the like. Using a code identifying a user, the software may only be activated if that user provides his personal identification code or biometric code.

After generation of the software release code, the software release code is stored in the second memory location of the device. All data for generating the software release code is as well stored in the secure first memory location as far as the data is not already available (device serial numbers and the like). Thus, the data such as the data retrieved from the data carrier is stored such that these data are not accessible to a user of the device. Therefore, a user cannot retrieve the data for generating the software release code. Instead of storing the data for generating the software release code, a copy of the software release code may be stored in the secure memory location. Alternatively, a copy of the software release code together with the data for generating the software release code may be stored in the secure memory location not accessible to a user.

It is noted that the first authorization data may be provided on the data carrier containing the software installation data. However, the first authorization data may as well be provided on any other carrier or may be available through a network such as the Internet. The software application installation data and first authorization data may be the same for each installation and may be produced in quantity without any difference between the copies. Such copies may be made on CD, DVD and the like or made available through a network such as the Internet. The second authorization data differ per copy, and, for example, may comprise identification data on a data carrier only readable using electronic means.

Storing data in a secure memory location not accessible to a user of the device and generating a software release code may be performed in any way known to a person skilled in the art, for example as disclosed in WO 2004 111752.

In a further aspect, the present invention provides a method for verifying authorized use of a software application installed on a first device in accordance with the method according to the present invention and connected to a data network, the method comprising:
establishing a data connection between the first device and a second device through the data network;
the first device accessing the data carrier to retrieve at least a part of the second authorization data;
providing said part of the second authorization data from the first device to the second device;
providing identification data of the first device to the second device;
storing said part of the second authorization data and the identification data by the second device, if the first device connects for the first time to the second device; and
comparing previously stored identification data and said part of the second authorization data by the second device, if the first device has previously connected to the second device, authorized use of the software application being verified if the part of the second authorization data and the identification data correspond to the stored part of the second authorization data and identification data.

The verification method according to the present invention may be employed, for example, when update software for the software application is to be downloaded from a software application owner server, i.e. a second device. The second device requests all data needed to regenerate the software release code from the first device, comprising at least a part of the second authorization data.

In the above description, reference is made to a software application. It is noted that the term software application is meant to comprise operating software and all other kinds of software.

Hereinafter, the present invention will be elucidated with reference to the appended drawings, in which:

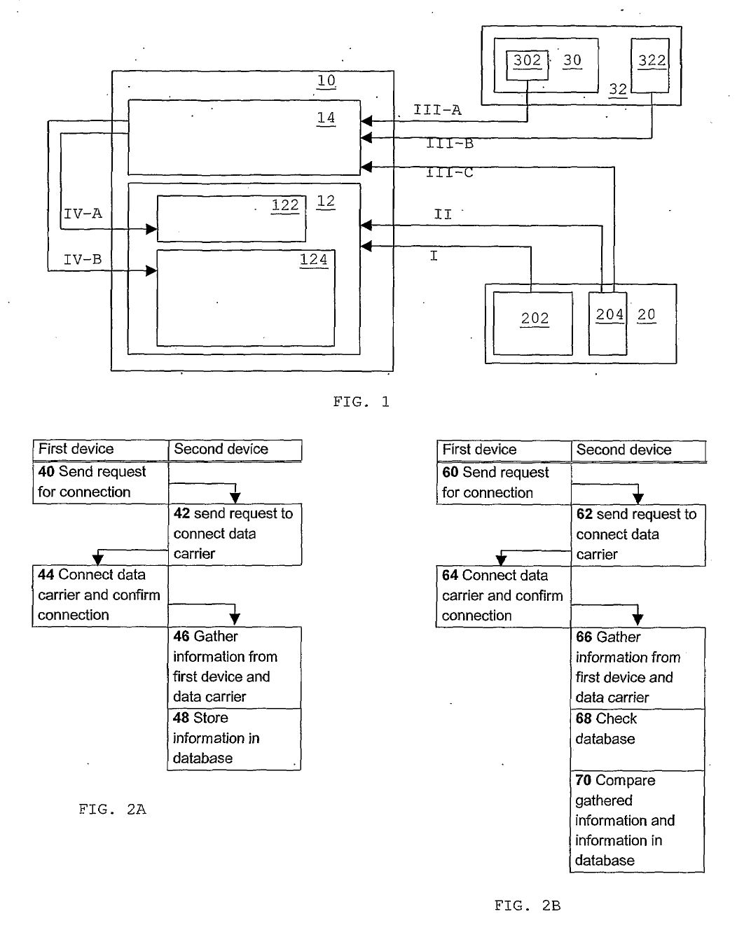

FIG. 1 illustrates a method for installing a software application on a device in accordance with the installation method of the present invention; and

FIGS. 2A-2B illustrate a method for verifying authorized use of a software application installed in accordance with the installation method of the present invention.

FIG. 1 schematically shows a device 10 comprising a memory 12 and an operating environment 14 for executing software applications. The memory 12 comprises a number of memory sections such as a memory 122 not accessible to a user and a magnetic storage device 124. The memory 12 may comprise further memory sections. Each memory section 122, 124 may be subdivided in a number of memory locations. Data stored in said memory locations may be encrypted.

FIG. 1 further shows a first data block 20 which is stored in a memory, e.g. a server memory, or on a data carrier, e.g. a CD-ROM or DVD-ROM, and a second data block 30 stored oh a data carrier 32. The first data block 20 may comprise software application installation data 202 and first authorization data 204. The second data block 30 comprises at least a part of second authorization data 302. The data carrier 32 is provided with identification data 322, such as a serial number or other data coupled to the data carrier or the like, which may be considered to be part of the second authorization data as is elucidated hereinafter.

The first data block 20 may be stored on a separate data carrier or may be stored on the data carrier 32 together with the second data block 30. It is noted that the first data block 20 comprises data that may be distributed freely, since the data comprised in the first data block 20 are not sufficient for installing the software application such that the application can be run.

When installing the software application, the software application installation data 202 and the first authorization data 204 are to be made available to the device on which the software application is to be installed as indicated by arrow I. The software application installation data 202 may comprise executable code for running the software application. This software application may be any kind of software application, e.g. an operating system, a device driver or a user application. The first authorization data 204 may comprise an authorization application to be installed on the device as indicated by arrow II and/or may comprise one or more decryption keys to be used during the installation of the software application. The authorization application may be incorporated in the software application.

During installation e.g. when activating the software application for the first time, the second data block 30 is to be made available to the device, as indicated by arrows III-A and III-B, by providing the data carrier 32 to a data carrier reader of, or coupled to, the device. The second data block 30 is an encrypted data block and therefore the data block 30 needs to be decrypted before the part of the second authorization data 302 is available to the device. The second data block 30 is associated with the data carrier 32 through encryption of the second data block 30 using the identification data 322 or coupled data of the data carrier 32 as an encryption key, or through such encryption that the identification data 322 are to be used as a decryption key. Thus, the second data block 30 can only be decrypted if it is still stored on the data carrier 32.

In an aspect, the second data block 30 is further encrypted using a second and possibly a further encryption key stored in the first authorization data 204 as mentioned above and as indicated by arrow III-C. Thus, the second data block 30 is protected against decryption without use of the first authorization data 204.

After making the second authorization data 302 accessible to the device e.g. by a user of the device, the software release code is generated by said device using the first and the second authorization data and preferably other data, such as data identifying the device and/or data identifying a user of the device to further enhance the protection against illegal use of the software application.

Before generation of the software release code, using the first and the second authorization data 204, 302 the authorization application has been installed on the device and at least one secure memory location not accessible to a user has been made available to said authorization application. A secure first memory location 122 is a part of a memory not accessible to a user of the device e.g. used by the BIOS of the device, or the like. In the secure first memory location 122 the authorization application may store the data for generating or regenerating a software release code and/or may store said generated software release code, as indicated by arrow IV-A.

Further, the software release code is stored in a second memory location 124, preferably not readable for a user, as indicated by arrow IV-B.

In an embodiment, at least a part of the second authorization data 302 stored on the data carrier 32 is altered during installation, thereby ensuring that the specific data carrier 32 cannot be used anymore for installing the software application. In a further embodiment, said part of the second authorization data 302 stored on the data carrier 32 is replaced by data that may be used to reinstall the software application on the specific device, e.g. after the previously installed software application has been corrupted. For example, the data replacing the part of the second authorization data 302 may comprise an encrypted copy of the software release code.

After installation of the software application, the authorization application, the software release code and at least one of a copy of the software release code and data for regenerating the software release code, the software application may be activated. At activation the authorization application, possibly incorporated in the software application, accesses the first memory location and the second memory location and either compares the software release code and the copy thereof or regenerates the software release code and compares the regenerated software release code and the stored software release code. If the software release code and one of the copy or the regenerated software release code correspond, the software application starts.

It is noted that the generation or regeneration of the software release code and possibly other encrypting and decrypting processing is preferably performed in a secure processing environment in order to prevent that a user may obtain the data and/or processes performed.

FIGS. 2A and 2B show a table having two columns, each column representing a device of a party, the devices being connected to each other, e.g. through a data network like the Internet. Each row of the table represents a method step. A software application has been installed on the device of the first party in accordance with the method illustrated by FIG. 1 and explained above.

In the example illustrated in FIG. 2A it is assumed that the first party attempts to connect to the device of the second party for the first time after installing the software application, for example to obtain an upgrade for the installed software application. Regardless of the reason for making the connection, the second party desires to verify whether the use of the software application is authorized, i.e. is legitimate. In accordance with the method shown in FIG. 1, the second party does not have any information on the first party yet.

In a first step 40 of the method, the first device sends a request for a connection to the second device. In response, in step 42, the second device sends a request to the first device to connect to the data carrier comprising the second authorization data. When the data carrier is connected, the first device confirms the connection in step 44.

Then, in step 46, the second device gathers information from the device of the first party and the data carrier connected thereto. For example, a BIOS serial number of the device, identifying the device, and the part of the second authorization data coupled to the data carrier is gathered and stored at the second party, e.g. in a database, in step 48. Thus, the specific data carrier is coupled to the specific device of the first party.

It is noted that in specific embodiments other data may as well be provided to the second party. For example, the software release code or an encrypted copy thereof may be provided to the second device and be stored in the database. Under circumstances, such a stored software release code may enable an authorized user to re-install a corrupted installation of the software application.

In FIG. 2B, the same first party connects to the same second party again as described in relation to and shown in FIG. 2A. Thus, in step 60, the first device sends a request to the second device for a connection. In step 62, in response, the second party sends a request to the first device to connect to the data carrier comprising the second authorization data. When the data carrier is connected to the first device, the first device confirms the connection in step 64.

Then, in step 66, the second device gathers information from the device of the first party and the data carrier connected thereto. For example, a BIOS serial number of the device, identifying the device, and the part of the second authorization data coupled to the data carrier is gathered. In step 68, the second device finds that the part of the second authorization data coupled to the data carrier has been registered in its database. In step 70, the second device compares the corresponding device identifying data received from the first device and retrieved from its database. If these two device identifying data correspond, it is determined that the first device is the same as previously registered and the connection is allowed or requested data is provided.

If the specific data carrier has been used to install the software application on a device of a third party, the device of the third party will not be able to connect to the device of the second party, since the specific data carrier has been registered to the device of the first party. The software application installed on the device of the third party will therefore be acknowledged as an illegal copy.

1. Method for protecting a software application against unauthorized use, the method comprising installing the software application, the installing comprising:
providing first authorization data and software application installation data;
a providing a data carrier carrying second authorization data, at least a part of said second authorization data being coupled to the specific data carrier on which the second authorization data is stored;
generating a software release code using at least the first authorization data and the second authorization data;
storing at least one of data for regenerating the software release code and the software release code in a secure first memory location such that said data are not accessible to a user of the device;
storing a copy of the software release code in a second memory location of said device.

2. Method according to claim 1, wherein the second memory location is an encrypted memory location.

3. Method according to claim 1, wherein the secure first memory location is an encrypted memory location.

4. Method according to claim 1, wherein the software release code is generated further using device specific data.

5. Method according to claim 1, wherein the software release code is generated further using user specific data.

6. Method according to claim 1, wherein the data carrier is an electronic data carrier.

7. Method according to claim 6, wherein a serial number of the data carrier is a part of the second authorization data.

8. Method according to claim 6, the method further comprising deleting at least a part of the second authorization data on the data carrier.

9. Method according to claim 6 or 7, the method further comprising altering at least a part of the second authorization data on the data carrier.

10. Method for controlling activation of a software application installed according to the method of claim 1, the method comprising:
retrieving the software release code from the first secure memory location;
retrieving a copy of the software release code from the second memory location;
comparing the copy of the software release code and the software release code;
activating the software application, if the software release code and the copy of the software release code correspond to each other.

11. Method according to claim 10, wherein retrieving the software release code from the first secure memory location comprises:
retrieving data for regenerating the software release code; and
regenerating the software release code.

12. Method for verifying authorized use of a software application installed on a first device connected to a data network in accordance with the method according to claim 1, the method comprising:
a establishing a data connection between the first device and a second device through the data network;
the first device accessing the data carrier to retrieve at least a part of the second authorization data;
providing said part of the second authorization data from the first device to the second device;
a providing identification data of the first device to the second device;
the second device storing said part of the second authorization data and the identification data, if the first device connects for the first time to the second device; and
the second device comparing previously stored identification data and said part of the second authorization data, if the first device has previously connected to the second device, authorized use of the software application being verified if the part of the second authorization data and the identification data correspond to the stored part of the second authorization data and identification data.

13. Method according to claim 12, wherein the part of the second authorization data and the software release code are stored in a memory of the second device together with data identifying the first device, if authorized use is verified.
